(19) United States
(12) Patent Application Publication
(10) Pub. No.: US 2009/0107736 A1
(43) Pub. Date: Apr. 30, 2009

(54) LAMINATED DIGITIZER SENSOR

(75) Inventors: Aviezer BEN-ELIYAHU, Tzur-Hadassa (IL); Yulia Aksenton, Jerusalem (IL); Ohad Israel Balila, Haifa (IL)

Correspondence Address: MARTIN D. MOYNIHAN d/b/a PRTSI, INC., P.O. BOX 16446, ARLINGTON, VA, 22215, US

(73) Assignee: N-trig Ltd., Kfar-Saba (IL)

(21) Appl. No.: 12/259,340

(22) Filed: Oct. 28, 2008

Related U.S. Application Data
(60) Provisional application No. 61/000,900, filed on Oct. 30, 2007.

(51) Int. Cl. G06F 3/041

(52) U.S. Cl. 178/18.01

(57) ABSTRACT

A laminated transparent digitizer sensor assembly comprises a first transparent layer patterned on one surface with a first array of conductors and an array of conductive elements electrically isolated from the first array of conductors; and a second transparent layer patterned on one surface with a second array of conductors; wherein the first and second layers are laminated with non-conducting transparent laminating material, such that the patterned surfaces face each others and wherein conductive material is provided between the conductive elements and conductors of the second array of conductors.

### RELATED APPLICATION/S

The present application claims the benefit under section 35 U.S.C. §119(e) of U.S. Provisional Application No. 61/000,900 filed on Oct. 30, 2007 which is incorporated herein by reference in its entirety.

### FIELD OF THE INVENTION

The present invention, in some embodiments thereof, relates to sensors formed by conductive material patterned on at least two superimposed substrates and, more particularly, but not exclusively, to electrical connection between the conductive material and electrical components associated with the sensor.

### BACKGROUND OF THE INVENTION

Digitizing systems that allow a user to operate a computing device with a stylus and/or finger are known. Typically, a digitizer is integrated with a display screen, e.g. over-laid on the display screen, to correlate user input, e.g. stylus interaction and/or finger touch on the screen with the virtual information portrayed on display screen. Position detection of the stylus and/or fingers detected provides input to the computing device and is interpreted as user commands. Typically, input to the digitizer sensor is based on Electro-Magnetic (EM) transmission provided by the stylus touching the sensing surface and/or capacitive means provided by the finger touching the screen.

U.S. Pat. No. 6,690,156 entitled “Physical Object Location Apparatus and Method and a Platform using the same” and U.S. Pat. No. 7,292,229 entitled “Transparent Digitizer” both of which are assigned to N-trig Ltd., the contents of both which are incorporated herein by reference, describe a positioning device capable of locating multiple physical objects positioned on a Flat Panel Display (FPD) and a transparent digitizer sensor that can be incorporated into an electronic device, typically over an active display screen of the electronic device. The digitizer sensor includes a matrix of vertical and horizontal conductive lines to sense an electric signal. Typically, the matrix is formed from conductive lines etched on two transparent foils that are superimposed on each other. Positioning the physical object at a specific location on the digitizer provokes a signal whose position of origin may be detected.

U.S. Pat. No. 7,372,455, entitled “Touch Detection for a Digitizer” assigned to N-Trig Ltd., the contents of which is incorporated herein by reference, describes a detector for detecting both a stylus and touches by fingers or like body parts on a digitizer sensor. The detector typically includes a digitizer sensor with a grid of sensing conductive lines patterned on two polyethylene terephthalate (PET) foils, a source of oscillating electrical energy at a predetermined frequency, and detection circuitry for detecting a capacitive influence on the sensing conductive line when the oscillating electrical energy is applied, the capacitive influence being interpreted as a touch. The detector is capable of simultaneously detecting multiple finger touches.

U.S. Patent Application Publication No. US20070292983, entitled “Methods for Manufacturing a Sensor Assembly” assigned to N-Trig Ltd., the contents of which is incorporated herein by reference, describes methods for creating electrical and mechanical contacts between a sensor array and a printed circuit printed circuit boards (PCB) while avoiding lateral conductance between electrical pads located thereon. In an exemplary embodiment, the electrical pads are located on substrates such as PET foils, as well as brittle components, such as PCBs. In some embodiments, at least one non-conductive spacer is used to avoid lateral conductance between the pads.

U.S. Patent Application Publication No. US2008143683, entitled “PET-Based Touch Pad”, the contents of which is incorporated herein by reference, describes capacitance touch sensor panel created by forming columns made of a substantially transparent conductive material on one side of a first substrate, forming rows made of the substantially transparent conductive material on one side of a second substrate, adhering the two substrates together with adhesive, bringing column connections down to the second substrate using vias, and routing both the column and row connections to a single connection area on the second substrate.

PCT Publication WO 2004/016897, entitled “Laminated Glass and Structural Glass with Integrated Lighting, Sensors and Electronics”, the contents of which is incorporated herein by reference, describes laminated glass used as a carrying case for sensors contained within the transparent non-glass interlayers or air cavities of the laminated glass.

### SUMMARY OF THE INVENTION

According to an aspect of some embodiments of the present invention there is provided a laminated digitizer sensor manufactured from at least two substrates patterned with conductive material and an assembly for forming contact between the conductive material patterned on each of the at least two substrates and one or more electrical components associated with the digitizer sensor. According to some embodiments of the present invention, the laminated digitizer sensor is a laminated glass sensor that provides for low manufacturing costs.

An aspect of some embodiments of the present invention is the provision of a laminated transparent digitizer sensor assembly comprising: a first transparent layer patterned on one surface with a first array of conductors and an array of conductive elements electrically isolated from the first array of conductors; and a second transparent layer patterned on one surface with a second array of conductors; wherein the first and second layers are laminated with non-conducting transparent laminating material, such that the patterned surfaces face each other, and wherein conductive material is provided between the conductive elements and conductors of the second array of conductors.

Optionally, the first and second arrays of conductors are first and second arrays of conductive lines.

Optionally, the conductive material is an anisotropic conductive material.

Optionally, the anisotropic conductive material is conductive in an axis perpendicular to the patterned surfaces of the first and second layer.

Optionally, the first array of conductive lines is parallel to a first axis of a grid and the second array of conductive lines is parallel to a second axis of the grid and together the first and second arrays form a grid.

Optionally, the first and second layers are constructed from glass substrates.

Optionally, the sensor assembly comprises one or more spacers positioned between the first and second layer, the spacers defining a controlled distance between the first and second array of conducting lines.

Optionally, the extent of the second layer is such that ends of the first array of conductors as well as a portion of each of the conductive elements are exposed.

Optionally, the sensor assembly comprises at least one circuit board mounted over an area exposed on the first layer, the at least one circuit board electrically connected to at least a portion of the conductive lines of the first array of conductive lines and the array of conductive elements patterned on the first layer.

Optionally, the at least one circuit board includes conductive pads, wherein the conductive pads of the circuit board mate with conductive lines of the first array of conductive lines and with the array of conductive elements patterned on the first layer.

Optionally, the first layer is additionally patterned with conductive pads on at least one end the conductive lines of the first array of conductive lines.

Optionally, the first layer is additionally patterned with conductive pads on at least one end the conductive elements.

Optionally, the sensor assembly comprises at least one circuit board mounted over an area exposed on the first layer, the at least one circuit board electrically connected to at least a portion of the conductive pads of the first array of conductive lines and the array of conductive elements.

Optionally, the at least one circuit board includes conductive pads, wherein the conductive pads of the circuit board mate with conductive pads on the first layer.

Optionally, a surface of the first layer or second layer opposite the patterned surface is configured for user interaction with the digitizer sensor.

Optionally, the user interaction is at least one of stylus, fingertip touch, and a token.

Optionally, the conductors of the first and second array are transparent or are thin enough so that they do not substantially interfere with viewing an electronic display behind the lines.

An aspect of some embodiments of the present invention is the provision of a method for manufacturing a laminated transparent digitizer sensor assembly, the method comprising: patterning a surface of a first layer with a first array of conductors and an array of conductive elements electrically isolated from the first array of conductors; patterning a surface of a second layer with a second array of conductors; providing conductive material between at least a portion of each conductive elements of the array of conductive elements and conductors of second array of conductors; aligning the second layer over the first layer such that the patterned surfaces face each other; and providing non-conductive laminating material between the first and second layer.

Optionally, the first array of conductors is parallel to a first axis of a grid and the second array of conductors is parallel to a second axis of the grid and together the first and second arrays form a grid.

Optionally, the first and second layers are constructed from glass substrates.

Optionally, the method comprises positioning at least one spacer, the spacer operative to define a distance between the first and second layer of the laminated sensor.

Optionally, the at least one spacer is additionally operative to separate an area over which the conductive material is dispensed and the non-conductive material is dispensed.

Optionally, the method comprises dispensing a first non-conductive material having a first viscosity on the first layer to form a frame with one or more gaps over which the second layer is positioned; curing the first non-conductive material; and dispensing a second non-conductive material having a second viscosity lower than the first viscosity in between the first and second layer through the one or more gaps of the frame.

Optionally, the frame is the spacer.

Optionally, the method comprises dispensing conductive material over ends of the first array of conducting lines and over a portion of each of the conductive elements.

Optionally, the method comprises mounting at least one circuit board on ends of the first array of conductors as well as a portion of each of the conductive conductors.

Optionally, the at least one circuit board is an ‘L’ shaped circuit board including conductive pads that mate with each of the conductive lines and conductive elements on the first layer.

Optionally, the method comprises patterning conductive pads on ends of at least one of the first array of conductors and the array of conductive elements.

An aspect of some embodiments of the present invention is the provision of a laminated transparent digitizer sensor assembly comprising:

a first layer patterned on one surface with a first array of conductors;

a second layer patterned on one surface with a second array of conductors positioned over the first layer such that the patterned surfaces face each other; and

a circuit board positioned between the first and second layer at least along one edge of the layers; the circuit board including a front and back surface, wherein the circuit board is electrically connected to the first array of conductors from the back surface and to the second array of conductors from the front surface.

Optionally, the digitizer sensor comprises non-conducting transparent laminating material disposed between the first and second layer.

Optionally, the conductors are conducting lines.

Optionally, the first array of conductive lines is parallel to a first axis of a grid and the second array of conductive lines is parallel to a second axis of the grid and together the first and second arrays form a grid.

Optionally, the first and second layers are constructed from glass substrates.

Optionally, the sensor assembly comprises one or more spacers positioned between the first and second layer.

Optionally, the sensor assembly comprises a coil, the coil electrically connected to the circuit board and positioned around the at least one circuit board.

Optionally, a surface of the first layer or the second layer opposite the patterned surface is configured for user interaction with the digitizer sensor.

Optionally, the user interaction is at least one of stylus, fingertip touch, or token.

Optionally, the conductive lines of the first and second array are transparent or are thin enough so that they do not substantially interfere with viewing an electronic display behind the lines.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified block diagram of a prior art grid based digitizer system in accordance with some embodiments of the present invention;

FIG. 2A is a simplified cross sectional view of a prior art digitizer sensor patterned on PET foils;

FIG. 2B is a simplified cross sectional view of a prior art digitizer sensor assembly overlaid on a FPD;

FIG. 3A is a simplified diagram of a first and second substrate patterned with conductive lines for forming a sensor array in accordance with some embodiments of the present invention;

FIG. 3B is a simplified diagram of a first and second substrate patterned with conductive lines and conductive pads for forming a sensor array in accordance with some embodiments of the present invention;

FIG. 4 is a simplified cross sectional view of a sensor with a mounted PCB in accordance with some embodiments of the present invention;

FIG. 5 is a simplified isometric view of a sensor with a PCB to be mounted on the sensor in accordance with some embodiments of the present invention;

FIG. 6 is a simplified cross sectional view of digitizer overlaid on a display in accordance with some embodiments of the present invention;

FIG. 7 shows a simplified flow chart of an exemplary method for constructing a sensor grid in accordance with some embodiments of the present invention; and

FIG. 8 is a simplified diagram of a first and second substrate patterned with conductive lines and conductive pads for forming a sensor array in accordance with other embodiments of the present invention;

FIG. 9 is a simplified isometric view of sensor array integrated with a PCB in accordance with some embodiments of the present invention;

FIG. 10 is a simplified isometric view of an ‘L’ shaped PCB in accordance with some embodiments of the present invention;

FIGS. 11A and 11B are simplified cross sectional views of two sides of sensor grid integrated with the PCB in accordance with some embodiments of the present invention;

FIG. 12 is a simplified cross sectional view of digitizer overlaid on a display in accordance with some embodiments of the present invention; and

FIG. 13 shows a simplified flow chart of an exemplary method for constructing a laminated digitizer sensor including a PCB positioned between a first and second substrate in accordance with some embodiments of the present invention.

### DESCRIPTION OF SPECIFIC EMBODIMENTS OF THE INVENTION

The present invention, in some embodiments thereof, relates to sensors formed by conductive material patterned on at least two substrates and, more particularly, but not exclusively, to electrical connection between the conductive material and electrical components associated with the sensor.

An aspect of some embodiments of the present inventions provides for a digitizer sensor formed by a two dimensional grid of conductive lines where each axis and/or dimension of the grid is patterned on a separate substrate overlaid on each other to form a laminated digitizer sensing surface. According to some embodiments of the present invention, electrical components are electrically connected to at least one end of the conductive lines from each of the substrates. Typically, the electrical components provide for invoking a triggering signal on the conductive lines and/or for interrogating and/or detecting signals the conductive lines during user interaction with the digitizer sensing surface, e.g. the digitizer sensor. According to some embodiments of the present invention, the substrates are glass substrates.

Known digitizer sensors are typically manufactured from Indium Tin Oxide (ITO) patterned on one or more PET transparent foils. Although PET foils are advantageous in that they are flexible, light weight and relatively thin, the assembly process typically requires multiple curing and manual steps that may drive up assembly time and costs. The present inventors have found that for at least some applications, a digitizer sensor manufactured from ITO lines patterned on laminated glass can be advantageous. ITO patterning on glass is typically a cheaper more automated manufacturing process as compared to ITO on PET foils.

According to some embodiments of the present invention, the laminated glass sensor is formed by bonding a surface of a first glass substrate patterned with a first set of conductive lines to a surface of a second glass substrate patterned with second set of conductive lines so that the first and second glass substrate bonded together form a grid pattern. Typically, the first and second sets are perpendicular to each other. In some exemplary embodiments, bonding is with a transparent non-conductive material. According to some embodiments of the present invention, distance between the first and second pattern of conductive lines can be minimized and/or directly controlled by bonding the two substrates such that the surfaces patterned with the conductive lines are facing each other and filling a desired spacing and/or gap between them with the transparent non-conductive laminating material, e.g. resin layer.

In some known gird based digitizer systems, one or more PCB(s) are mounted directly on the substrates including the conductive lines. Typically, the PCB(s) are mounted along a border of the sensing surface on conductive pads connected to one end of each conductive line on the digitizing surface. In some known systems, a single ‘L’ shaped PCB is used to establish contact with conductive lines from both a column and row axis and/or X and Y axis of the grid based sensor. Typically, the PCB is mounted on a surface facing away from the user interaction surface with the digitizer, e.g. facing the display over which the digitizer sensor is positioned. Mounting the PCB such that it faces away from the user interaction surface provides for protecting electronic components mounted on PCB from damage due to handling, protects electrical components mounted on PCB from ambient noise, and also allows for a flat frame design that may be considered more aesthetic.

The present inventors have found that when constructing a laminated digitizer sensor having surfaces patterned with conductive lines that are facing each other, there is no common surface available from which a PCB can be mounted to form contact with conductive lines from both axes of the grid, e.g. both X and Y axes. One known solution is using vias through an additional layer to route the conductive lines from the two surfaces to a common surface on which a PCB can be mounted. This solution is particularly practical for formable material such as PET foil material. However, introducing vias for each conductive line patterned on a glass substrate is typically a costly procedure.

An aspect of some embodiments of the present inventions provides for a single surface from which electrical components associated with a digitizer sensor can establish electrical contact with conductive lines from each substrate of the laminated sensor. Typically, the first substrate includes a first set of parallel conductive lines in a Y direction and is overlaid on a second substrate including a second set of parallel conductive lines in an X direction such that the first and second set are orthogonal to each other and form a grid. According to some embodiments of the present invention, one or more substrates are formed with conductive pads at one end of the lines. Typically, the pads are formed on the same end for all the lines on a substrate, although this is not necessary. According to some embodiments of the present invention, the first substrate includes an additional conductive array that mate with the conductive lines on the second substrate along at least one edge of the substrate such that when the second substrate is overlaid on the first substrate to form a grid, each conductive lines of the second substrate overlaps an element of the conductive array on the first substrate. According to some embodiments of the present invention, conductive pads are patterned on one end of each of the conductive lines on the first substrate and on each end of the conductive element from the additional conductive array.

According to some embodiments of the present invention, conductive material is used to establish connection between the conductive lines of the second substrate and the conductive elements of the additional array on the first substrate. In some exemplary embodiments, anisotropic conductive material is used to establish the connection along one direction perpendicular to the patterned substrate surfaces, e.g. the Z direction, while avoiding shorting between contiguous conductive lines within the set.

According to some embodiments of the present invention, the extent of the second substrate is such that the conductive pads on the first substrate are exposed, e.g. the conductive pads associated with the conductive lines in the X and Y directions. According to some embodiments of the present invention, a PCB is mounted over the exposed area of the first substrate establishing contact between each of the conductive lines from the two substrates and electronic components mounted on the PCB. Optionally, the PCB makes direct contact with the conductive lines. Optionally, other substrates with electrical connections may be used instead of a PCB, e.g. circuit boards.

An aspect of some embodiments of the present inventions provides for a laminated sensor including a first and second substrate patterned with conductive lines such that the conductive lines of the first surface establish electrical contact with a back surface of the PCB and the conductive lines on second substrate establish electrical contact with the PCB from a front surface of the PCB. As used herein, the front surface of the PCB refers to the surface including the bulk of the electronic components and the back surface of the PCB is the surface opposite the front surface. According to some embodiments of the present invention, PCB is positioned between the laminated layers and contacts each of the layers from a different surface. According to some embodiments of the present invention, the PCB is s secured to the sensor during lamination so that the PCB and laminated sensor forms a single sensor assembly unit. According to some embodiments of the present invention, more than one PCB is used so that at least one first PCB establishes electrical contact with the conductive lines of the first substrate from a back surface of the first PCB and at least one other second PCB establishes electrical contact with the second substrate from a front surface of the second PCB.

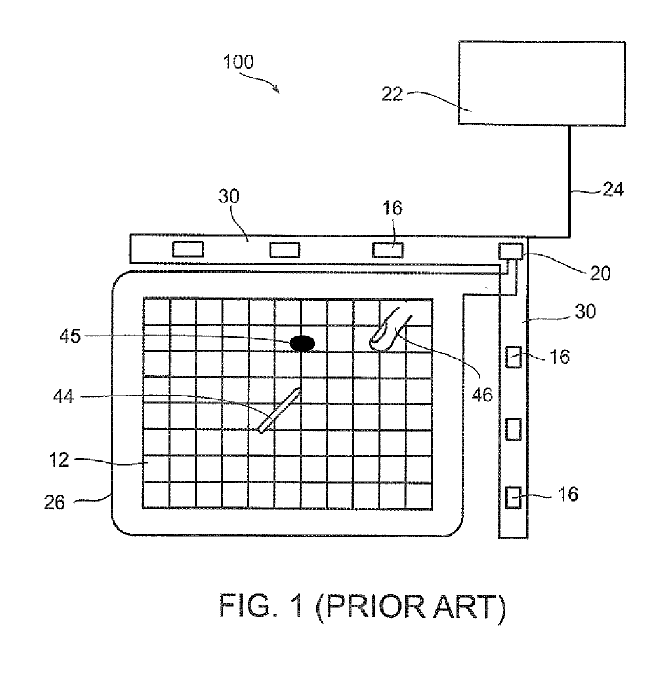

Referring now to the drawings, FIG. 1 illustrating an exemplary simplified block diagram of a prior art grid based digitizer system. Typically, the digitizer system 100 comprises a sensor 12 including a patterned arrangement of conductive lines, which is optionally transparent, and which is typically overlaid on a FPD. Typically sensor 12 is a grid based sensor including horizontal and vertical conductive lines.

Typically, circuitry is provided on one or more PCB(s) 30 positioned around sensor 12. Optionally, PCB 30 is an ‘L’ shaped PCB. Typically, one or more ASICs 16 positioned on PCB(s) 30 comprise circuitry to sample and process the sensor's output into a digital representation. Typically, the digital output signal is forwarded to a digital unit 20, e.g. digital ASIC unit also on PCB 30, for further digital processing. Typically, digital unit 20 together with ASIC 16 serves as the controller of the digitizer system and/or has functionality of a controller and/or processor. Output from the digitizer sensor is forwarded to a host 22 via an interface 24 for processing by the operating system or any current application.

Typically, sensor 12 comprises a grid of conductive lines made of conductive materials, optionally ITO, patterned on a glass substrate, foil and/or other substrate. The conductive lines and the substrate are optionally transparent or are thin enough so that they do not substantially interfere with viewing an electronic display behind the lines. Typically, the grid is made of two layers, which are electrically insulated from each other. Typically, one of the layers contains a first set of equally spaced parallel conductive lines and the other layer contains a second set of equally spaced parallel conductive lines orthogonal to the first set. Typically, the parallel conductive lines are input to amplifiers included in ASIC 16.

Typically, the parallel conductive lines are spaced at a distance of approximately 2-8 mm, e.g. 4 mm, depending on the size of the FPD and a desired resolution. Optionally the region between the grid lines is filled with a non-conducting material having optical characteristics similar to that of the (transparent) conductive lines, to mask the presence of the conductive lines. Optionally, the ends of the lines remote from the amplifiers are not connected so that the lines do not form loops.

Typically, ASIC 16 is connected to outputs of the various conductive lines in the grid and functions to process the received signals at a first processing stage. As indicated above, ASIC 16 typically includes an array of amplifiers to amplify the sensor's signals. Additionally, ASIC 16 optionally includes one or more filters to remove frequencies that do not correspond to frequency ranges used for excitation and/or obtained from objects used for user interactions. The signal is then sampled by an A/D, optionally filtered by a digital filter and forwarded to digital ASIC unit 20, for further digital processing.

Typically, digital unit 20 receives the sampled data from ASIC 16, reads the sampled data, processes it and determines and/or tracks the position of physical objects, such as a stylus 44 and a token 45 and/or a finger 46, and/or an electronic tag touching the digitizer sensor from the received and processed signals. Typically, digital unit 20 determines the presence and/or absence of physical objects, such as stylus 44, and/or finger 46 over time. Optionally, hovering of an object, e.g. stylus 44, finger 46 and token is also detected and processed by digital unit 20. Calculated position and/or tracking information are sent to the host computer via interface 24.

According to some embodiments of the invention, digital unit 20 produces and controls the timing and sending of a triggering pulse to be provided to an excitation coil 26 that surrounds the sensor arrangement and the display screen. The excitation coil provides a trigger pulse in the form of an electric or electromagnetic field that excites passive circuitry in stylus 44 or other object used for user interaction to produce a response from the stylus that can subsequently be detected. In some exemplary embodiments, an excitation coil is not included.

According to some embodiments, digital unit 20 produces and sends a triggering pulse to at least one of the conductive lines. Typically the triggering pulses and/or signals are analog pulses and/or signals. According to some embodiments of the present invention, the triggering pulse and/or signal implemented may be confined to one or more pre-defined frequencies, e.g. 18 KHz or 20-40 KHz. In some exemplary embodiments, finger touch detection is facilitated when sending a triggering pulse to the conductive lines.

In an exemplary embodiment, an AC signal is applied to one or more parallel conductive lines in the two-dimensional sensor matrix 12. When a finger 41 touches the sensor at a certain position where the signal is induced on a line, the capacitance between the conductive line through which the signal is applied and the corresponding orthogonal conductive lines at least proximal to the touch position increases and the signal crosses by virtue of the capacitance of finger 41 to corresponding orthogonal conductive lines to producing a lower amplitude signal, e.g. lower in reference to a base-line amplitude. This method is able to detect more than one finger touch and/or capacitive object at the same time (multi-touch).

Host 22 includes at least a memory unit and a processing unit to store and process information obtained from ASIC 16 and digital unit 20. Typically, an electronic display associated with the host computer displays images. Optionally, the images are displayed on a display screen situated below a surface on which the object is placed and below the sensors that sense the physical objects or fingers. Optionally, the surface functions as a game board and the object is a gaming piece, or a toy. Typically, digitizer sensor operates as a user input device to host 22. Typically, host 22 maps input from digitizer sensor 12 to one or more functions of an application running on host 22 and displayed on the electronic display.

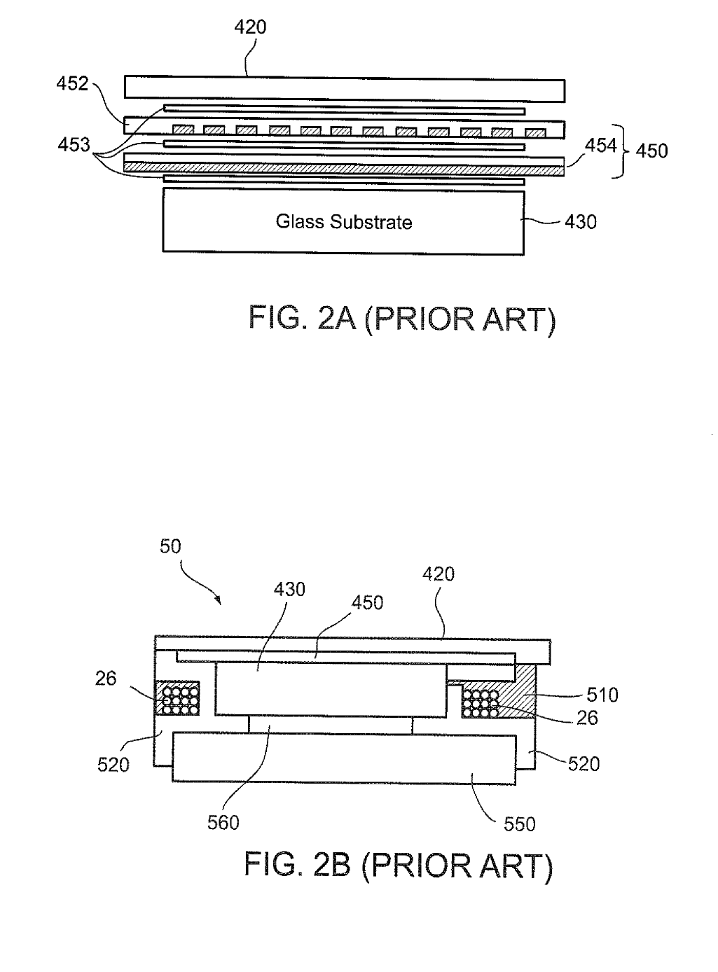

Reference is now made to FIG. 2A showing a simplified cross sectional view of a prior art digitizer sensor patterned on PET foils. Typically, the digitizer sensor 12 is constructed from four layers. The first layer 430 is a substrate, which is typically a transparent material such as glass or plastic, used for mechanical support. The second layer 454 is a PET foil patterned with conductive lines in a first direction. The third layer 452 is also a PET foil whereas the patterned conductive lines are orthogonal to the second layer's conductive lines. Second and third layers 452 and 454 constitute the conductive grid 450 of the sensor. Typically, carbon pads are printed on the edge of the transparent conductors to enable connection to PCB 30. Typically, the extent of each layer is such that the carbon pads from each of the layers are exposed. The top layer 420 is a hard coating layer providing the user interaction surface and is used to protect the sensor. Typically, a pressure sensitive adhesive (PSA) 453 is used to connect the layers.

Reference is now made to FIG. 2B showing a simplified cross sectional view of a prior art digitizer sensor assembly overlaid on a FPD. Sensor assembly 50 includes sensor grid 450 overlaid on a glass substrate 430, ‘L’ shaped PCB 30, a sensor frame 520 and a peripheral coil 26 winded around the sensor frame. Frame 520 provides mechanical stability to sensor assembly 50, secures peripheral coil 26 to a fixed position, and keeps the sensor assembly aligned with the LCD 550. PCB 30 positioned around sensor grid 450 includes at least the digital ASIC controller 20 and several analog ASICs 16. Optionally a flexible cable connects PCB 30 to host 22. Typically, the sensor assembly is mounted on top of the display screen (such as LCD) using adhesive strips. Optionally an air gap 560 is formed between the glass substrate and the LCD. Optionally, non-conducting adhesive 510 is used to secure coil 26 in place.

According to some embodiments of the present invention, there is provided a digitizer sensor construction including facing patterned surfaces that can be used in place of a known construction of digitizer sensor 12. According to some embodiments of the present invention, each of the surfaces is patterned with conductors, e.g. conductors of the sensor. According to some embodiments of the present invention, the digitizer sensor provided is particularly suited for digitizer sensors constructed from conductive lines patterned on layers of rigid substrates, e.g. glass substrates. However, it is noted that the digitizer sensor described herein may also be applicable to digitizer sensor construction from any known substrate including pliable substrates, e.g. PET foils.

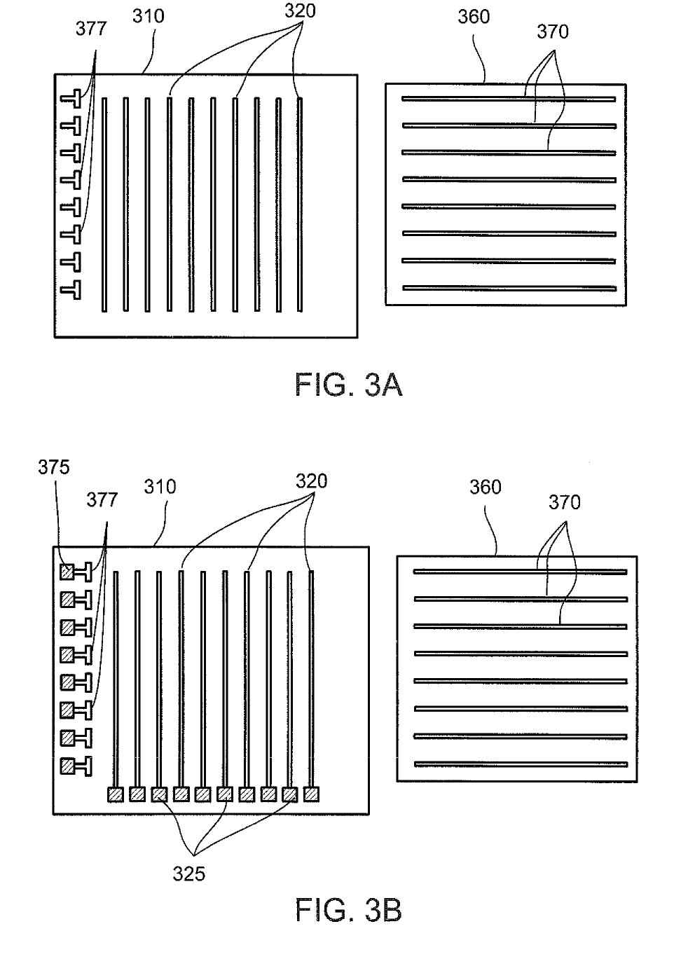

Reference is now made to FIG. 3A showing a simplified diagram of a first and second substrate patterned with conductive lines for forming a sensor grid in accordance with some embodiments of the present invention. According to some embodiments of the present invention, the first and second substrates are the layers of a laminated digitizer sensor. According to some embodiments of the present invention, a first substrate 310 is patterned on one surface with a first set and/or array of conductive lines 320 in a Y direction. According to some embodiments of the present invention, a second substrate 360 is patterned on one surface with a second set and/or array of conductive lines 370 in an X direction.

Typically, each of arrays 320 and 370 are constructed from a set of straight, parallel lines that are equally spaced, although other configurations are possible. In some exemplary embodiments, conductive lines of each array are spaced at a distance of approximately 2-10 mm, e.g. 4 mm, depending on the size of the FPD and a desired resolution.

According to some embodiments of the present invention, first substrate 310 includes an additional set of conductive elements 377 along one edge of first substrate 310 that mate with ends of conductive lines 370. According to some embodiments of the present invention, conductive elements 377 are electrically isolated from conductive lines 320. In some exemplary embodiments, conductive elements 377 are ‘T’ shaped and the caps of the ‘T’ provide for increasing tolerances for alignment with conductive lines 370 with patterns 377. Optionally, patterns 377 can have other shapes and/or can be a line. According to some embodiments of the present invention, conductive elements 377 are operative to establish electrical contact with conductive lines 370 when overlaid on first substrate 310. Optionally, conductive elements 377 may be included along two opposite edges of first substrate 310 and may mate with both or either ends of conductive lines 370.

In some exemplary embodiments, conductive lines 320, 370, and conductive elements 377 are patterned from ITO. In some exemplary embodiments, conductive lines 320 and 370 are patterned by printing transparent conductive nano-tube inks on the substrates. Optionally, the conductive lines are not transparent but are thin enough so that they do not substantially interfere with viewing an electronic display positioned behind the lines.

Reference is now made to FIG. 3B showing a simplified diagram of a first and second substrate patterned with conductive lines and pads for forming a sensor grid in accordance with some embodiments of the present invention. In some exemplary embodiments, first substrate 310 is formed with conductive pads 325 at one end of conductive lines 320 and at or near an edge of substrate 310. In some exemplary embodiments, first substrate 310 is formed with conductive pads 375 at one end of conductive elements 377 and at or near another edge of substrate 310. Typically, pads 325 and 375 provide for a contact area on which electrical contact may be established between the conductive lines and a PCB or electronic components associated with the digitizer sensor. Typically, all of pads 325 are formed on the same end of conductive lines 320 and all of pads 375 are formed on the same end of conductive patterns 377 and one or more PCBs are mounted on those ends. However, this is not required and pads 325 may be formed on either and/or both ends of conductive lines 320. Optionally, pads 325 and 375 are formed with graphitic or silver material.

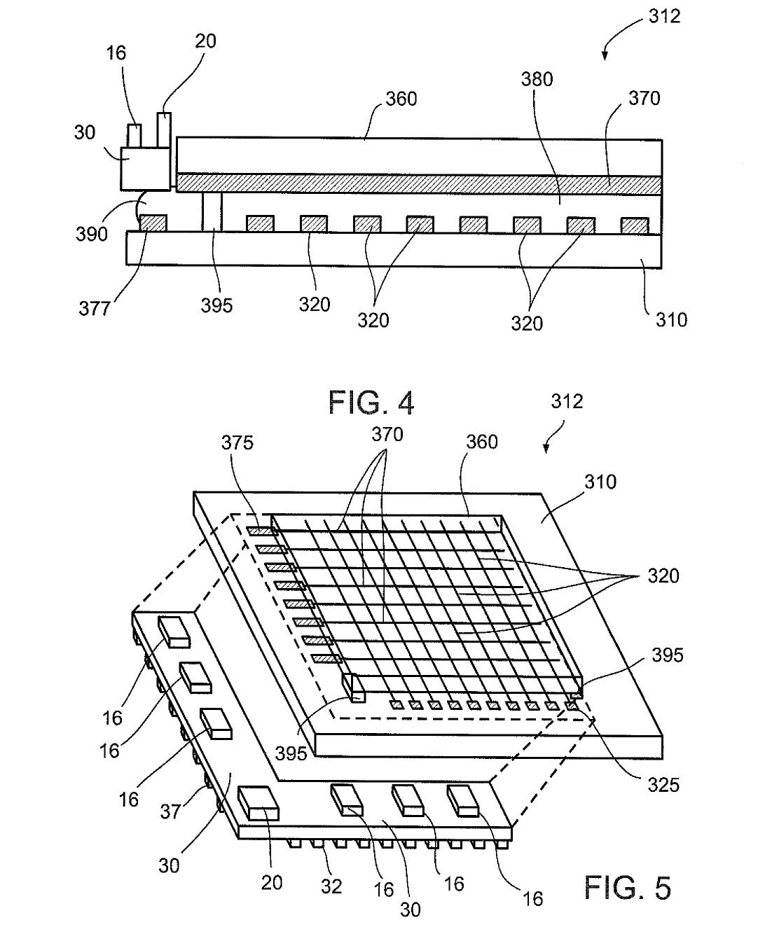

Reference is now made to FIG. 4 showing a simplified cross sectional view of a sensor 312 with a mounted PCB and FIG. 5 showing a simplified isometric view of a sensor 312 with a PCB to be mounted on the sensor both in accordance with some embodiments of the present invention. According to some embodiments of the present invention, second substrate 360 is overlaid on first substrate 310 such that the surfaces of each of the substrates patterned with the conductive lines are facing each other and together form a grid of conductive lines. According to some embodiments of the present invention, second substrate 360 is aligned on first substrate 310 such that conductive lines 370 patterned on second substrate 360 mate with conductive elements 377 patterned on first substrate 310. According to some embodiments of the present invention, the mating is such that it provides for electrical contact between conductive lines 370 and conductive elements 377 while leaving a portion of each of conductive elements 377 exposed. Optionally, if conductive pads 375 are used, conductive pads 375 are exposed. According to some embodiments of the present invention, the extent of second substrate 360 is such the ends of conductive lines 320 from at least one end are exposed. Optionally, if conductive pads 325 are used, conductive pads 325 are exposed.

According to some embodiments of the present invention, conductive material 390 is dispensed and/or layered over conductive elements 377, to provide for electrical conductance between elements 377 and conductive lines 370 prior to overlaying substrate 360 on substrate 310. In some exemplary embodiments, one or more spacers 395 are provided for separating area over which non-conductive and conductive material is dispensed. In some exemplary embodiments, non-conducting spacers are provided between each of elements 377 to avoid lateral conductance when conductive material 390 is placed on conductive elements 377. According to some embodiments of the present invention, conductive material 390 is an isotropic conductive material that is operative provide conductance in the Z direction while avoiding shorting of contiguous lines by lateral conductance. Exemplary anisotropic conductive materials 390 include anisotropic conductive film (ACF), anisotropic conductive paste (ACP), Z-axis conductive material and/or adhesive, and Z-axis connectors. The anisotropic property of the bonding material provides electrical communication between conductive elements and lines on different layers while avoiding electrical communication, e.g. avoiding shorts, between contiguous lines and/or conductive pads. In some exemplary embodiments, shorting of contiguous lines is prevented by dispensing conductive material 390 over each conductive elements 377 and in between conductive patterns 377 dispensing non-conducting material. Optionally, the dispensed non-conductive material functions as a spacer. Typically, the layer of conductive material 390 is a bonding material.

According to some embodiments of the present invention, electrical isolation layer between conductive lines 320 and conductive lines 370 is provided by a non-conducting laminating material 380. Typically, the laminating material is transparent. In some exemplary embodiments, the laminated material is a resin, e.g. an ultra violet (UV) curable resin. According to some embodiments of the present invention, a thickness of laminating material layer 380 is controlled to provide for a required and pre-defined distance and/or gap between the first and second array of conductive lines. According to some embodiments of the present invention, one or more spacers 395 are used to set the pre-defined distance between the first and second array of conductive lines and laminating material 380 is used to fill the space between the first and second array of conductive lines. In some exemplary embodiments, the pre-defined distance between the first and second array of conductive lines and/or between the facing surfaces of the first and second substrate is between 0.1-0.6 mm.

According to some embodiments of the present invention, non-conductive laminating material is restricted to area where the lines in the X and Y direction overlap and does not cover the conductive elements 377, pads and/or one or more ends of the conductive lines. Typically, the layer of the conductive material has the same thickness of the layer of non-conductive material so that the spacing between the substrates is filled.

Since the pre-defined distance between the first and second array of conductive lines is set by the spacers and/or thickness of the laminating layer, it is possible to use relatively thicker substrates with greater tolerances as compared to prior art substrates used to form the sensor grid. In some exemplary embodiments, the thickness of the first and second substrate may be between 0.5 and 1.5 mm. In some exemplary embodiments, the substrate facing the display is thinner than the substrate over which user interaction is provided. In some exemplary embodiments, the substrate facing the display, e.g. second substrate 360, is between 0.5-0.8 mm thick. According to some embodiments of the present invention, a distance of 0.5-0.8 mm between the sensor grid and the LCD helps to reduce noise on the grid from the LCD. In some exemplary embodiments, the thickness of the substrate over which user interaction is provided, e.g. first substrate 310, is between 0.5-1.1 mm thick.

According to some embodiments of the present invention, a PCB 30 is mounted over the exposed pads patterned on first substrate 310. Optionally, when conductive pads aren't used PCB 30 is mounted over the parts of the conductive elements 377 that are exposed and exposed ends of conductive lines 320. According to some embodiments of the present invention, PCB 30 includes a first array of conductive pads 32 associated with conductive lines 320 in the Y direction and a second array of conductive pads 37 that are associated with conductive lines 370 in the X direction. When mounting PCB 30 on first substrate 310, PCB 30 is positioned such that pads 32 on PCB 30 face and align with pads 325 on first substrate 310 and pads 37 on PCB 30 are aligned with pads 375 on first substrate 310. Typically, PCB 30 is an ‘L’ shaped PCB. Alternatively, more than one PCB is used and/or a PCB is connected to all four ends of first substrate 310, e.g. on both ends of conductive lines 320 and 370.

In an exemplary embodiment of the invention, the electric and/or conductive pads located on the PCB and first substrate mate with a conductive connection provided by the conductive adhesive. In some exemplary embodiments of the invention, spacers are used to avoid creation of lateral conductivity between the electric pads after a conductive adhesive is applied and pressed. Methods for bonding PCB 30 to substrate 310 may be similar to methods described in incorporated US Patent Application Publication US20070292983.

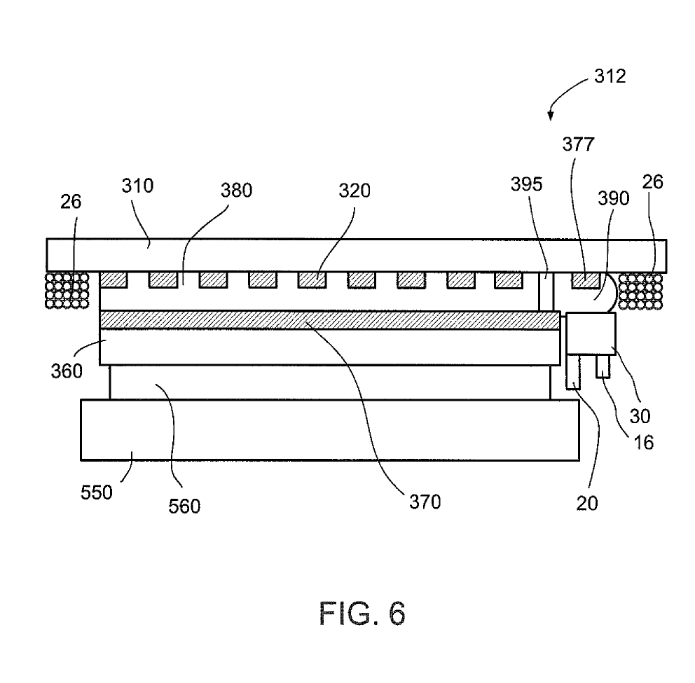

Reference is now made to FIG. 6 showing a simplified cross sectional view of digitizer sensor assembly overlaid on a display in accordance with some embodiments of the present invention. According to some embodiments of the present invention, the digitizer assembly shown in FIG. 6 can replace the prior art digitizer assembly shown in FIGS. 2A and 2B and may be integrated with the digitizer system described in reference to FIG. 1 According to some embodiments of the present invention, the sensor assembly including sensor grid 312, excitation coil 26 and PCB 30 is positioned over display 550, e.g. LCD. Typically, PCB 30 includes electrical components such as the digital ASIC controller 20, and several analog ASICs 16. Optionally a flex cable connects PCB 30 to host 22. Typically, the digitizer assembly is mounted on top of the display screen (such as LCD) using adhesive strips. Optionally an air gap 560 is formed between the glass substrate and the display. Optionally, a frame surrounds sensor 312 and provides mechanical stability to the sensor assembly, e.g. secures peripheral coil 26 to a fixed position, and keeps the sensor assembly aligned with the LCD 550. In some exemplary embodiments, coil 26 is fixed to first glass substrate 310. Optionally, the coil is positioned and fixed around PCB 30. In some exemplary embodiment of the invention, coil 26 a self supported coil, e.g. doesn't require wounding a wire on a core, and is an independent unit. Optionally, the coil is constructed from a copper wire coated with insulating material, such as insulating varnish.

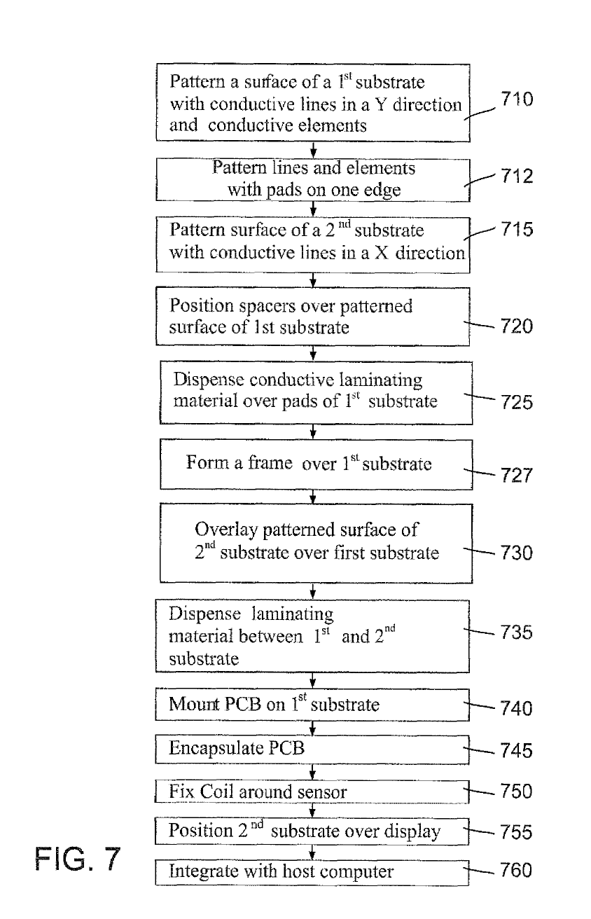

Reference is now made to FIG. 7 showing a simplified flow chart of an exemplary method for constructing a digitizer sensor assembly in accordance with some embodiments of the present invention. According to some embodiments of the present invention, a surface of first substrate 310 is patterned with an array of conductive lines 320 in the Y direction, and an additional array of conductive elements 377 (block 710). In some exemplary embodiments, conductive pads 325 are patterned on one or more ends of conductive lines 320 and conductive pads 375 on ends of conductive elements 377 (block 712). According to some embodiments of the present invention, a surface of second substrate 360 is patterned with an array of conductive lines 370 in an X direction (block 715).

According to some embodiments of the present invention, one or more spacers 395 are positioned over the patterned surface of first substrate 310 (block 720). Typically, spacers 395 are operative to provide for a pre-defined distance between the first and second substrate. Typically spacers 395 are constructed from non-conductive material. According to some embodiments of the present invention, spacer 395 provides for a gap of about 0.15-0.16 mm between the first and second substrate.

In some exemplary embodiments, spacers 395 operate as a barrier between a non-conductive laminating material 380 and a conductive laminating material 390 to be dispensed between the laminated layers. Optionally spacers are positioned between lines 320 and/or conductive pattern 377.

According to some embodiments of the present invention, conductive material 390 is dispensed over areas of pads and/or conductive line ends and/or conductive pattern end 377 of first substrate 310 (block 725). In some exemplary embodiments, conductive material 390 is an ACF. In some exemplary embodiments, conductive material 390 is ACP. In some exemplary embodiments, conductive material 390 functions as spacer 395 operative to define gap between the first and second substrate.

In some exemplary embodiments, prior to overlaying the second substrate, non-conducting laminating material 380 with a relatively high viscosity is dispensed over first substrate 310 to form a partial frame and/or barrier within which the rest of the laminating material 380, between the first and second substrate may be contained (block 727). Typically, the frame includes one or more gaps though which the rest of the laminating material may be provided. In some exemplary embodiments, conductive material 390 is used as a partial frame and/or barrier. In some exemplary embodiments, conductive material 390 is dispensed after the non-conducting frame is cured. Optionally, filling of conductive material is accomplished by using a capillary effect when the dispensing is performed from a parallel axis to the conductive.

According to some embodiments of the present invention, second substrate 360 is overlaid and aligned over first substrate and the laminated material forming the frame is cured (block 730). According to some embodiments of the present invention, laminating material is provided between first substrate 310 and second substrate 360 (block 735). In some exemplary embodiments, laminating material is dispensed through gaps formed in the cured frame. In some exemplary embodiments, the laminating material used to form the frame has a higher viscosity than the laminating material used to fill the gap within the frame. For example, laminating material for forming the frame may have a viscosity of about 10-100 cP while the laminating material used to fill gap formed by frame is about 5 cP. In some exemplary embodiments, the frame is operable to contain the lower viscosity laminating material during dispensing. Optionally, filling is achieved by creating a vacuum, where the material is introduced from one end while pumping from one or more other ends. Optionally, a vacuum is achieved by applying pressure on the glass substrates during application of the laminating material and then releasing the pressure. According to some embodiments of the present invention, the second laminating material is cured.

According to some embodiments of the present invention, PCB 30 is mounted over first substrate 310 along a border formed by the extent of second substrate 360 (block 740). In some exemplary embodiments of the invention, non-conductive laminating material is inserted into all the air gaps on PCB substrate as well as the gaps in and around peripheral coil to encapsulate the sensor assembly (block 745). Optionally, the encapsulation by the same material used for lamination. According to some embodiments of the present invention, coil 26 is fixed around sensor (block 750). Optionally, coil 26 is positioned around sensor prior to encapsulation, and the encapsulation procedure serves to fix coil in place. According to some embodiments of the present invention, encapsulated sensor assembly is positioned over a display such that second substrate 360 faces the display (block 755) and the sensor assembly is integrated with host computer by establishing electrical communication between digitizer sensor assembly and host, e.g. vial cable 24 (block 760). In some exemplary embodiments, coil 26 is not used and is not part of the sensor assembly. Typically the extent of first substrate is such that both PCB 30 and coil 26 can be mounted on the patterned surface of the first substrate.

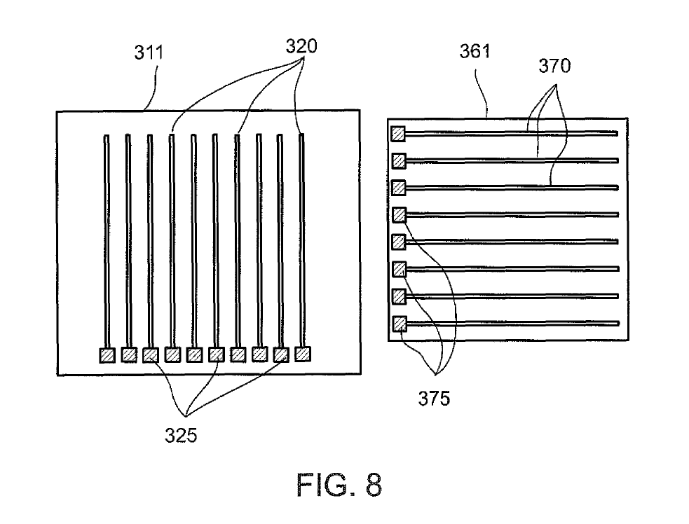

Reference is now made to FIG. 8 showing a simplified diagram of a first and second substrate patterned with conductive lines and pads for forming a sensor grid in accordance with other embodiments of the present invention. According to some embodiments of the present invention, the first and second substrates are the layers of a laminated digitizer sensor. According to some embodiments of the present invention, a first substrate 310 is patterned on one surface with a first set and/or array of conductive lines 320 in a Y direction. According to some embodiments of the present invention, a to second substrate 360 is patterned on one surface with a second set and/or array of conductive lines 370 in an X direction.

Typically, each of arrays 320 and 370 are constructed from a set of straight, parallel lines that are equally spaced, although other configurations are possible. In some exemplary embodiments, conductive lines of each array are spaced at a distance of approximately 2-10 mm, e.g. 4 mm, depending on the size of the FPD and a desired resolution.

In some exemplary embodiments, first substrate 311 is formed with conductive pads 325 at one end of conductive lines 320 and at or near an edge of substrate 311. In some exemplary embodiments, second substrate 361 is formed with conductive pads 375 at one end of conductive lines 370 and at or near an edge of substrate 361. Typically, pads 325 and 375 provide for a contact area on which electrical contact may be established between the conductive lines and one or more PCBs or electronic components associated with the digitizer sensor. Typically, all of pads are formed on the same end of the conductive lines. However, this is not required and the pads may be formed on either and/or both ends of conductive lines. Optionally, pads 325 and 375 are formed with graphitic or silver material.

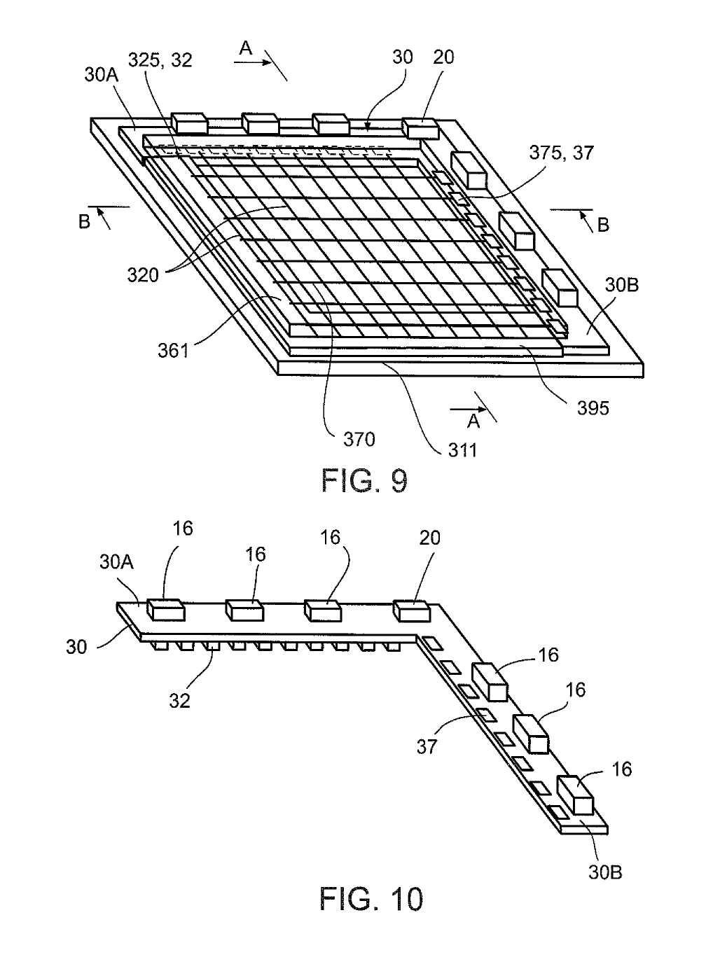

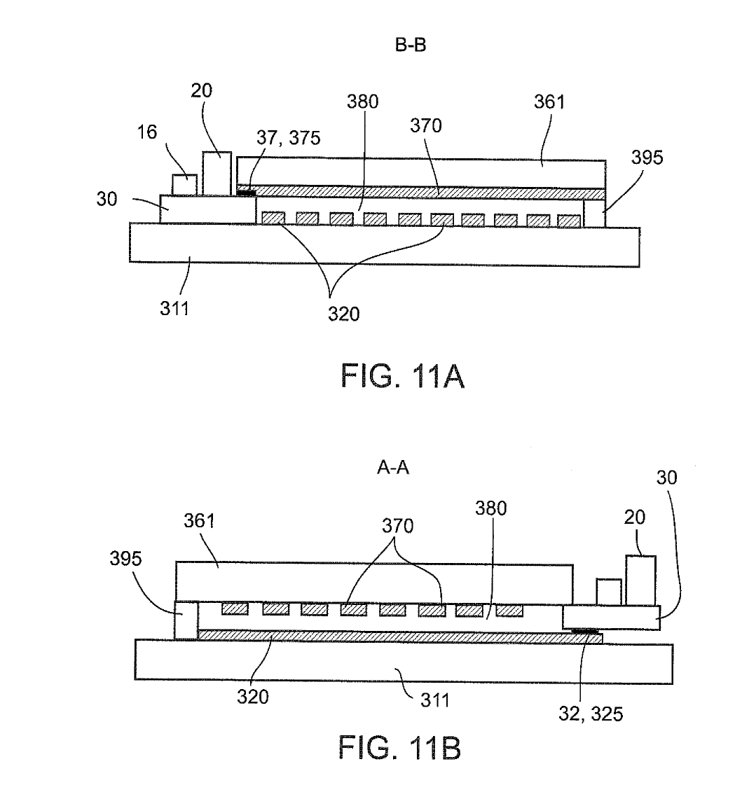

Reference is now made to FIG. 9 showing a simplified isometric view of the sensor grid integrated with a PCB, FIG. 10 showing a simplified isometric view of the PCB, and to FIGS. 11A and 11B showing simplified cross sectional views in the X and Y direction respectively of a sensor grid integrated with a PCB in accordance with some embodiments of the present invention. According to some embodiments of the present invention a sensor grid and PCB laminated assembly is constructed from a first substrate 311 patterned with an array of conductive lines 320 in a Y direction, a second substrate 361 overlaid on the first substrate and patterned with an array of conductive lines 370 in a X direction, and a PCB 30 sandwiched between the first and second substrate along at least two edges of substrates. According to some embodiments of the present invention, substrate 361 is overlaid on substrate 311 such that the surfaces patterned with the conductive lines are facing each other. In some exemplary embodiments, PCB 30 establishes contact directly with conductive lines 320 and 370. Typically, PCB 30 has a thickness of about 0.5 mm and the electronic components mounted on PCB 30 have a height of about 0.5 mm. Typically the separation between the first and second substrate is between 0.5-0.7 mm and/or corresponds to the thickness of the PCB.

According to some embodiments of the present invention, the PCB 30 is ‘L’ shaped including a first leg 30A through which electrical contact is established with conductive lines 320 on the first substrate and second leg 30B through which electrical contact is established with conductive lines 370 on the second substrate. According to some embodiments of the present invention, PCB 30 establishes electrical contact with conductive lines 320 through an array of conductive pads 32 on one surface of PCB 30, e.g. back surface of PCB 30, positioned along leg 30A and establishes electrical contact with conductive lines 370 through an array of conductive pads 37 (FIG. 10) on an opposite surface of PCB 30, e.g. front surface of PCB 30, positioned along leg 30B. According to some embodiments of the present invention, electrical components, e.g. ASICs 16 and digital unit 20 together with other electronic components are mounted on the front surface of PCB 30, e.g. on the same surface on which conductive pads 37 are formed. Optionally, electrical components are mounted on both sides of the PCB. According to some embodiments of the present invention, PCB 30 is secured between first substrate 311 and second substrate 320 and electrical connection between PCB 30 and the conductive lines is provided by applying conductive adhesive on conductive pads on PCB 30 and/or the conductive pads on the first and second substrates. According to some embodiments of the present invention, anisotropic conductive material and/or other conductive material is used to bond each substrate to the PCB and provide for electrical contact. In some exemplary embodiments, anisotropic bonding material is dispensed along an edge of a substrate including conductive pads and/or ends of conductive lines. In some exemplary embodiments, shorting of contiguous lines is prevented by dispensing conductive material, e.g. isotropic conductive material and/or other conductive material (adhesive), over each conductive lines end and/or pad and in between pads and/or lines dispensing non-conducting material. In some exemplary embodiments, a non-conductive spacer is positioned between conductive lines and function to prevent shorting between lines and set the distance between the substrates, e.g. for desired heights that are greater than the height of the PCB.

In some exemplary embodiments of the present invention, more than one PCB is used to establish contact between conductive lines 320 and 370 and electrical components associated with the sensor. In some exemplary embodiments, separate PCBs are used for the first and second substrate. In some exemplary embodiments, the separate PCBs are electrically connected through a flexible PCB. In some exemplary embodiments, the separate PCBs are electrically connected through wire bonding. In some exemplary embodiments, a PCB is positioned on both ends of conductive lines 320 and/or conductive lines 370 to establish electrical contact with one or more ends of the conductive lines.

According to some embodiments of the present invention, one or more spacers 395 are positioned between the first and second substrate to provide for the required and/or desired gap between the first and second array of conductive lines. In some exemplary embodiments, the spacer is an ‘L’ shaped spacer. Typically, the height of the spacer corresponds to the thickness of the PCB. According to some embodiments of the present invention, spacer 395 provides for a distance and/or separation of 0.5-0.6 mm between first substrate 311 and second substrate 361.

According to embodiments of the present invention, laminating material 380 is dispensed between the first and second substrate to form a laminated sensor unit including PCB 30. According to some embodiments of the present invention, one or more channels are formed through the PCB through which laminating material is injected. In some exemplary embodiments, channels having diameters of at least 0.1-0.2 mm are used to inject laminating material. Typically, the dimensions of the channels depend on the viscosity of the bonding material injected through the channels.

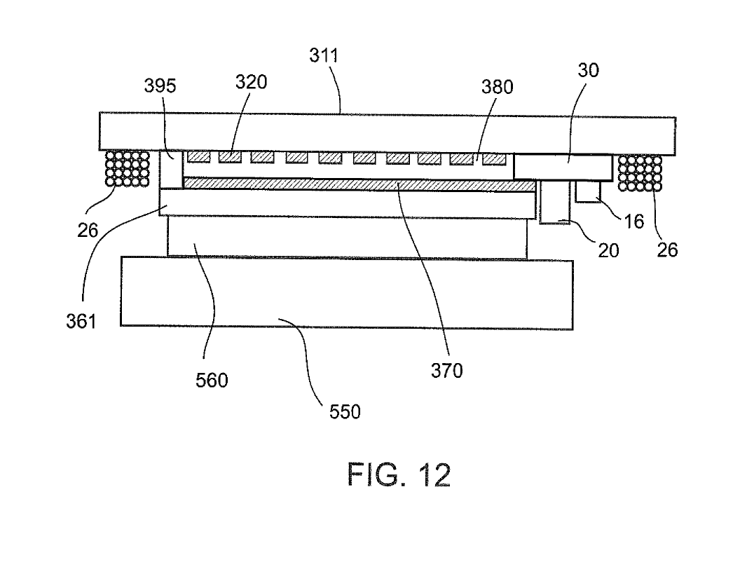

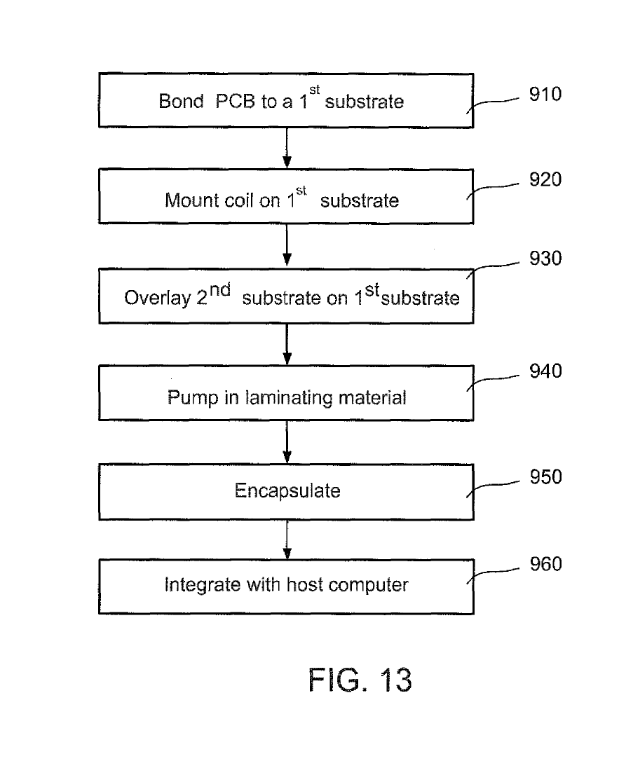

Reference is now made to FIG. 12 showing a simplified cross sectional view of digitizer overlaid on a display and to FIG. 13 showing a simplified flow chart of an exemplary method for constructing a laminated digitizer sensor including a PCB positioned between a first and second substrate in accordance with some embodiments of the present invention. According to some embodiments of the present invention, the digitizer assembly shown in FIG. 12 can replace the prior art digitizer assembly shown in FIGS. 2A and 2B and may be integrated with the digitizer system described in reference to FIG. 1. According to some embodiments of the present invention, PCB 30 is mounted along at least two edges of a first substrate including a first array of parallel conductive lines (block 910). Typically, PCB 30 is bonded to first substrate 311 using an anisotropic conductive material along an edge of first substrate 311 including conductive pads 325 and non conductive material along the other edge. Optionally, PCB is connected to conductive lines 320. According to some embodiments of the present invention, coil 26 is positioned around PCB 30 and on the outskirts of first substrate 311 (block 920). Typically the extent of first substrate is such that both PCB 30 and coil 26 can be mounted on the patterned surface of the first substrate. According to some embodiments of the present invention, second substrate patterned with conductive lines 361 is mounted over PCB 30 and over first substrate 311 such that the patterned surface of substrate 361 faces the patterned surface of substrate 311 (block 930). According to some embodiments of the present invention, second substrate is aligned over PCB 30 so that conductive pads 375 are mounted over conductive pads 37 of PCB 30. In some exemplary embodiments, one or more spacers 395 are mounted on first substrate and/or second substrate to define the gap between the first and second substrate, e.g. an L-shape spacer. Typically, the dimensions of the second substrate are extends over a smaller area as compared to the substrate.

According to some embodiments, laminating material is used to fill the gap between the first and second substrate (block 940) thereby bonding the two surfaces. In some exemplary embodiments laminating material is injected through channels formed on the PCB. In some exemplary embodiments, the laminating material is a non-conductive transparent UV curable resin. In some exemplary embodiments, an acrylic resin or polyester resin is used as the laminating material. Optionally, an epoxy is used for laminating. In some exemplary embodiments, the laminating material used has a low viscosity, e.g. a viscosity of approximately 5 cP is used. Optionally, the lamination is achieved by creating a vacuum, where the material is introduced from one end while pumping from one or more other ends. Optionally, a vacuum is achieved by applying pressure on the glass substrates during application of the laminating material and then releasing the pressure. 311361. In some exemplary embodiments, PCB 30 and coil 26 provide a frame for containing the laminating material and prevent it from leaking out during dispensing.

According to some embodiments of the present invention, the digitizer sensor including first and second substrate, PCB and coil are encapsulated with non-conducting material (block 950). Typically, non-conductive adhesive is inserted into all the air gaps on PCB substrate as well as the gaps in and around peripheral coil. Typically, encapsulation protects and provides mechanical stability to the digitizer sensor. In some exemplary embodiments, encapsulation is performed together with lamination process and the same material is used. In some exemplary embodiments, the sensor is encapsulated with polymer material. According to some embodiments of the present invention, the digitizer sensor positioned over a display unit such that the second substrate 361 faces the display and the digitizer is integrated with a host computer, e.g. a personal computer (block 960).

It is noted that although the present invention has been described such that first substrate 311 is patterned with conductive lines in the Y direction while second substrate 361 is patterned with conductive lines in the X direction, the opposite arrangement may also be used in accordance with embodiments of the present invention. For example, first substrate 311 may be patterned with conductive lines in the X direction while second substrate 361 may be patterned with conductive lines in the Y direction. It is also noted that the present invention is not limited to an orthogonal grid structure. Other grid structures may be applied and are within the scope of the present invention. It is also noted that although the present invention has been mostly described as providing a digitizer system structure such that electric components on a PCB generally face away from the digitizer user interaction surface, the present invention is not limited to such a configuration.

The present invention is not limited to the technical description of the digitizer system and sensor assemblies described herein. Digitizer systems and sensor modules used to detect stylus and/or fingertip location may be, for example, similar to digitizer systems described in incorporated U.S. Pat. No. 6,690,156, U.S. Pat. No, 7,292,229, U.S. Pat. No. 7,372,455, U.S. Patent Application Publication No. US20070292983 and U.S. Patent Application Publication No. US2008143683. The present invention may also be applicable to touch screen sensors that are not digitizer sensors, e.g. capacitive sensors.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

What is claimed is:

1. A laminated transparent digitizer sensor comprising:
a first transparent layer patterned on one surface with a first array of conductors and an array of conductive elements electrically isolated from the first array of conductors; and
a second transparent layer patterned on one surface with a second array of conductors;
wherein the first and second layers are laminated with non-conducting transparent laminating material, such that the patterned surfaces face each other, and wherein conductive material is provided between the conductive elements and conductors of the second array of conductors.

2. The sensor according to claim 1, wherein the first and second arrays of conductors are first and second arrays of conductive lines.

3. The sensor according to claim 1, wherein the conductive material is an anisotropic conductive material.

4. The sensor according to claim 3 wherein the anisotropic conductive material is conductive in an axis perpendicular to the patterned surfaces of the first and second layer.

5. The sensor according to claim 2, wherein the first array of conductive lines is parallel to a first axis of a grid and the second array of conductive lines is parallel to a second axis of the grid and together the first and second array form a grid.

6. The sensor according to claim 1, wherein the first and second layers are constructed from glass substrates.

7. The sensor according to claim 1 comprising one or more spacers positioned between the first and second layer, the spacers defining a controlled distance between the first and second array of conducting lines.

8. The sensor according to claim 1, wherein the extent of the second layer is such that ends of the first array of conductors as well as a portion of each of the conductive elements are exposed.

9. The sensor according to claim 8, wherein the sensor is configured for mounting at least one circuit board mounted over an area exposed on the first layer, the at least one circuit board configured for being electrically connected to at least a portion of the conductive lines of the first array of conductive lines and the array of conductive elements patterned on the first layer.

10. The sensor assembly according to claim 9, wherein the at least one circuit board includes conductive pads, wherein the conductive pads of the circuit board are configured for mating with conductive lines of the first array of conductive lines and with the array of conductive elements patterned on the first layer.

11. The sensor assembly according to claim 2, wherein the first layer is additionally patterned with conductive pads on at least one end the conductive lines of the first array of conductive lines.

12. The sensor assembly according to claim 11, wherein the first layer is additionally patterned with conductive pads on at least one end the conductive elements.

13. The sensor assembly according to claim 12, wherein the sensor is configured for mounting at least one circuit board over an area exposed on the first layer, the at least one circuit board configured for being electrically connected to at least a portion of the conductive pads of the first array of conductive lines and the array of conductive elements.

14. The sensor assembly according to claim 13, wherein the at least one circuit board includes conductive pads, wherein the conductive pads of the circuit board are configured to mate with conductive pads on the first layer.

15. The sensor assembly according to claim 1, wherein a surface of the first layer or second layer opposite the patterned surface is configured for user interaction with the digitizer sensor.

16. The sensor assembly according to claim 15 wherein the user interaction is at least one of stylus, fingertip touch, and a token.

17. The sensor assembly according to claim 1, wherein the conductors of the first and second array are transparent or are thin enough so that they do not substantially interfere with viewing an electronic display behind the lines.

18. A method for manufacturing a laminated transparent digitizer sensor assembly, the method comprising:
patterning a surface of a first layer with a first array of conductors and an array of conductive elements electrically isolated from the first array of conductors;
patterning a surface of a second layer with a second array of conductors;
providing conductive material between at least a portion of each conductive elements of the array of conductive elements and conductors of second array of conductors;
aligning the second layer over the first layer such that the patterned surfaces face each other; and
providing non-conductive laminating material between the first and second layer.

19. The method according to claim 18 wherein the first array of conductors is parallel to a first axis of a grid and the second array of conductors is parallel to a second axis of the grid and together the first and second arrays form a grid.

20. The method according to claim 18, wherein the first and second layers are constructed from glass substrates.

21. The method according to claim 18 comprising positioning at least one spacer, the spacer operative to define a distance between the first and second layer of the laminated sensor.

22. The method according to claim 21, wherein the at least one spacer is additionally operative to separate an area over which the conductive material is dispensed and the non-conductive material is dispensed.

23. The method according claim 18 comprising:
dispensing a first non-conductive material having a first viscosity on the first layer to form a frame with one or more gaps over which the second layer is positioned;
curing the first non-conductive material; and
dispensing a second non-conductive material having a second viscosity lower than the first viscosity in between the first and second layer through the one or more gaps of the frame.

24. The method according to claim 23 wherein the frame is the spacer.

25. The method according to claim 18, comprising dispensing conductive material over ends of the first array of conducting lines and over a portion of each of the conductive elements.

26. The method according to claim 18 comprising mounting at least one circuit board on ends of the first array of conductors as well as a portion of each of the conductive conductors.

27. The method according to claim 26 wherein the at least one circuit board is an ‘L’ shaped circuit board including conductive pads that mate with each of the conductive lines and conductive elements on the first layer.

28. The method according to claim 18 comprising patterning conductive pads on ends of at least one of the first array of conductors and the array of conductive elements.

29. A laminated transparent digitizer sensor assembly comprising:
a first layer patterned on one surface with a first array of conductors;
a second layer patterned on one surface with a second array of conductors positioned over the first layer such that the patterned surfaces face each other; and
a circuit board positioned between the first and second layer at least along one edge of the layers; the circuit board including a front and back surface, wherein the circuit board is electrically connected to the first array of conductors from the back surface and to the second array of conductors from the front surface.

30. The sensor assembly according to claim 29 comprising non-conducting transparent laminating material disposed between the first and second layer.

31. The sensor assembly according to claim 29, wherein the conductors are conducting lines.

32. The sensor assembly according to claim 29, wherein the first array of conductive lines is parallel to a first axis of a grid and the second array of conductive lines is parallel to a second axis of the grid and together the first and second arrays form a grid.

33. The sensor assembly according to claim 29, wherein the first and second layers are constructed from glass substrates.

34. The sensor assembly according to claim 29 comprising one or more spacers positioned between the first and second layer.

35. The sensor assembly according to claim 29 comprising a coil, the coil electrically connected to the circuit board and positioned around the at least one circuit board.

36. The sensor assembly according to claim 29, wherein a surface of the first layer or the second layer opposite the patterned surface is configured for user interaction with the digitizer sensor.

37. The sensor assembly according to claim 36, wherein the user interaction is at least one of stylus, fingertip touch, or token.

38. The sensor assembly according to claim 29, wherein the conductive lines of the first and second array are transparent or are thin enough so that they do not substantially interfere with viewing an electronic display behind the lines.
